(19) United States
(12) Patent Application Publication
(10) Pub. No.: US 2018/0232406 A1
(43) Pub. Date: Aug. 16, 2018

(54) BIG DATA DATABASE SYSTEM

(71) Applicant: SYSCOM COMPUTER ENGINEERING CO., TAIPEI CITY (TW)

(72) Inventors: TZE-JEN YU, TAIPEI CITY (TW); KUN-TING CHIU, TAIPEI CITY (TW); SHU-YUAN HU, TAIPEI CITY (TW); PEI-FEN HU, TAIPEI CITY (TW)

(21) Appl. No.: 15/430,544

(22) Filed: Feb. 13, 2017

(51) Int. Cl. G06F 17/30; H04L 29/08; H04L 12/24

(52) U.S. Cl. CPC G06F 17/30297; H04L 41/024; H04L 67/1097

(57) ABSTRACT

A big data database system created in a language structure of a SQL database and a language structure of a NoSQL database is provided for accessing data after clients have requested for a connection, and the system includes at least one transfer server and a data host, and the transfer server has a plurality of queuing devices and an assigner, and the queuing devices are telecommunicatively coupled to the clients respectively, and the assigner is telecommunicatively coupled to the queuing devices and the data host. When the clients send out a data request, the respective queuing device receives and queues the data request, and the assigner sends the data request to the data host through a single connection between the transfer server and the data host. Therefore, the connection load of the data host of a terminal is reduced to improve the overall system operation performance.

### FIELD OF THE INVENTION

The present invention relates to the field of databases, particularly to a big data database system created in a relational database of a structural query language (SQL) technology and a non-relational database (NoSQL database) technology, and an intermediate device is provided to organize and assign a connection task to reduce the connection load of a terminal host to improve the overall database operation performance.

### BACKGROUND OF THE INVENTION

### 1. Description of the Related Art

In 2012, an article “The Age of Big Data” published in The New York Times officially declared the advent of the era of big data, and the term “Big Data” can be said to be familiar to everyone thereafter. When the volume of accumulated data becomes increasingly larger, databases are facing challenges of high read/write requirement, high storage efficiency, high access and high scalability. For example, a general notification relational database adopts synchronous ad symmetric connection structure to access data through a number of connections equal to the number of clients in order to achieve a powerful data query capability. However, such server-client distributed database is limited by the load capability of hardware equipments since the number of connections has to be equal to the number of clients. When there is a need of accessing big data, the original hardware equipments must be expanded, upgraded or replaced with a higher specification, and thus incurring a higher cost as well as a higher level of difficulty for the operation.

Although the non-relational database using distributed storage and computation to process data has the advantages of a low hardware equipment cost and a high expandability, yet the non-relational database also adopt the synchronous and symmetric connection structure. As a result, it is also necessary to expand or upgrade the original hardware equipment to access big data in the non-relational database. Since the non-relational database adopts a new programming language, therefore it has a very weak query capability, and also has a high error rate while writing and outputting a large quantity of data, and the programming language is still not well developed to maintain a low version upgrade risk, and thus reducing the safety and stability of the database, which is not conducive to the industrial development with a high risk requirement.

To take the real-time, accuracy and safety of the relational database and the high scalability and scalability of the non-relational database into consideration, a SQL+NoSQL database 1 as shown in FIG. 1 is developed, and the SQL+NoSQL database 1 comprises a plurality of clients 10 connected to a SQL database 11 which is connected to a NoSQL database 12, and the NoSQL database 12 has a data table (not shown in the figure) provided for data query. Since the clients 10 connected to the SQL database 11 through a SQL language, and the SQL database 11 communicates with the NoSQL database 12 by a translation by a new programming language, so that the data query capability is still weak. In addition, the SQL+NoSQL database 1 still has a synchronous and symmetric connection structure, and although it has a horizontal expandability, yet the overall system still relies on the translation for the communication between the SQL database 11 and the NoSQL database 12. As to the overall system, the expanded database has to bear a higher workload and extends the query time and thus is not conducive to its industrial applications.

In view of the drawbacks of the prior art, it is an important subject for the present invention to improve the conventional database structure or provide a novel database structure in order to reduce the number of connections or load of the database, while ensuring the work efficiency of converting data into information.

### 2. Summary of the Invention

Therefore, it is a primary objective of the present invention to overcome the drawbacks of the prior art by providing a big data database system with a high scalability to reduce the network load of a data host while maintaining a high capability of processing the data requests for the network connections of at least 400K clients, so as to achieve a high-quality operation of big data.

To achieve the aforementioned objective, the present invention discloses a big data database system created in a language structure of a SQL database and a language structure of a NoSQL database and provided for accessing data after a plurality of clients have requested for a network connection, characterized in that the big data database system comprises at least one transfer server and a data host, and the transfer server includes a plurality of queuing devices and an assigner, and the queuing devices are respectively and telecommunicatively coupled to the clients, and the assigner is telecommunicatively coupled to the queuing devices and the data host, so that when one of the clients sends out a data request, the respective queuing device receives and queues the data request, and the assigner sends the data request to the data host through a single connection between the transfer server and the data host.

Wherein, the assigner sends the data requests to the data host sequentially according to a first-in-first-out message mechanism after reading the data requests from the queuing devices, and the queuing devices are installed to be corresponsive to the clients respectively, so that each client is connected to the respective queuing device, and when the transfer server come with a plural quantity, and if the quantity of transfer servers is equal to a, then the quantity of network connections between the data host and the transfer servers will also be equal to a.

In addition, the transfer server and the clients adopt a language technology of a relational database structure, and the transfer server and the data host adopts a language technology of a non-relational database structure.

In summation, the present invention adopts the assigner to do the translation work of the new programming language to overcome the issue of a low data query performance of the conventional NoSQL database and also adopts the sequence of using the queuing devices and the assigner to process the data requests, so as to overcome the issue of having equal number of clients and network connections as required in the conventional SQL database, NoSQL database, or SQL+NoSQL database. In other words, the present invention no longer requires distributing a corresponding thread for each data request for data processing and responses. Even if the quantity of clients increases, or the data requests increases drastically, the data host still can process data or respond by a single connection with the transfer server through the coordination of the assigner, so that the overload of network connections will not occur anymore. Further, the big data database system of the present invention is used for the exchange of messages and implemented with different data processing methods.

### BRIEF DESCRIPTION OF THE DRAWINGS

FIG. 1 is a schematic view of a conventional SQL+NoSQL database structure;

FIG. 2 is a schematic view of a preferred embodiment of the present invention;

FIG. 3 is a flow chart of a preferred embodiment of the present invention;

FIG. 4 is a schematic view of using a preferred embodiment of the present invention; and

FIG. 5 is a schematic view of applying a preferred embodiment of the present invention.

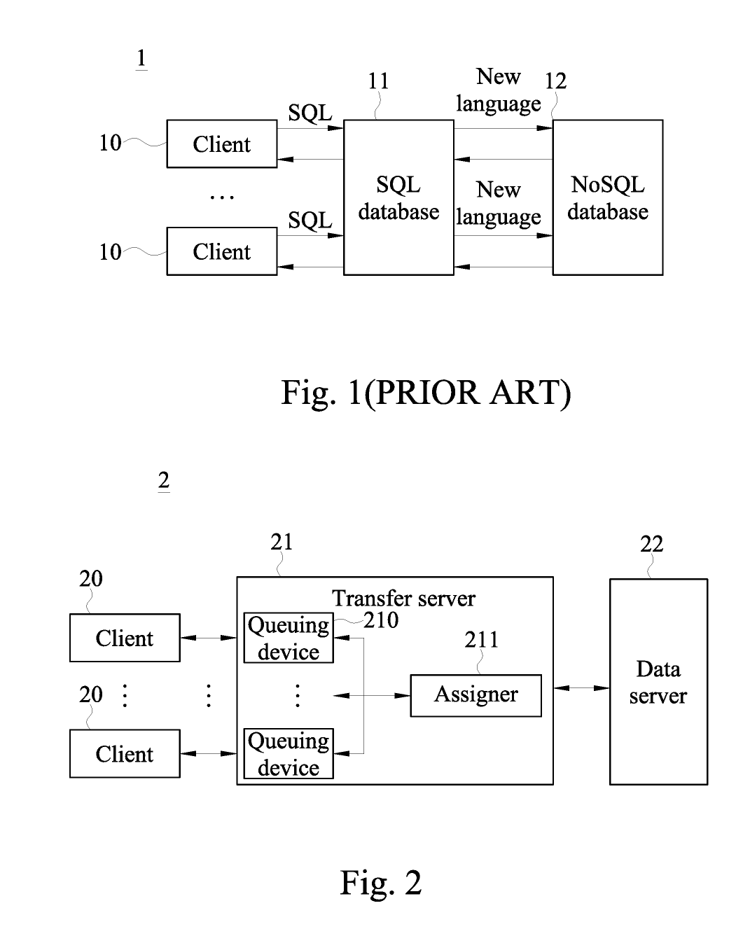

### DESCRIPTION OF THE PREFERRED EMBODIMENTS

The above and other objects, features and advantages of this disclosure will become apparent from the following detailed description taken with the accompanying drawings.

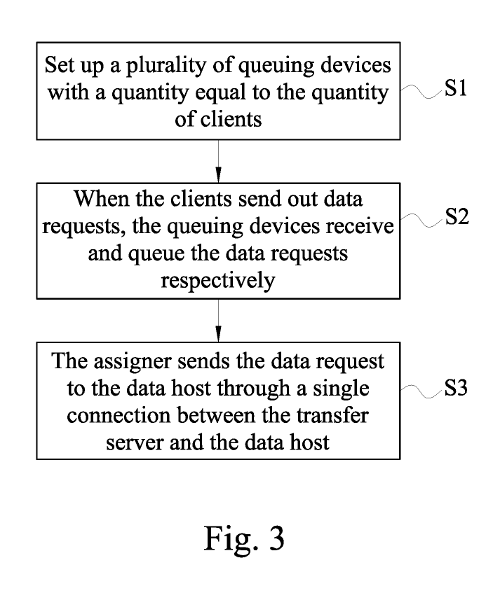

With reference to FIGS. 2 and 3 for a schematic view and a flow chart of a big data database system in accordance with a preferred embodiment of the present invention respectively, the big data database system 2 created in a language structure of a SQL database and a language structure of a NoSQL database and provided for accessing data after a plurality of clients 20 have requested for a network connection comprises at least one transfer server 21 and a data host 22. The transfer server 21 includes a plurality of queuing devices 210 and an assigner 211, and the queuing devices 210 are respectively and telecommunicatively coupled to the clients 20 and communicated through a language technology of a relational database structure, and the assigner 211 is telecommunicatively coupled to the queuing devices 210 and the data host 22 and communicated with the data host 22 through a language technology of a non-relational database structure. The operation of the big data database system 2 comprises the following steps.

S1: if the quantity of clients 20 is equal to N, the same quantity of queuing devices 210 will be installed, so that the transfer server 21 has N queuing devices 210, and each queuing device 210 is connected to each respective client 20. In other words, there are N network connections between the transfer server(s) 21 and the clients 20.

S2: When any one of the clients 20 sends out a data request, the respective queuing device 210 receives and queues the data requests. In other words, an instruction, transaction or request for use transmitted from each client 20 is written into each queuing device 210 by using a SQL language. In the meantime, each queuing device 210 sends a request notice to the assigner 211, and a large quantity of data requests are stored in the transfer server 21, so that the assigner 211 creates a thread for executing the data requests by stages.

S3: The assigner 211 reads the data requests from the queuing devices 210 according to a first-in-first-out message mechanism and translates the data request into a programming language recognizable by the data host 22, and the single connection between the transfer server 21 and the data host 22 sequentially sends the data requests to the data host 22, so that the thread of each respective queuing device 210 coordinated by such message mechanism have different nodes for work, so as to allow the data host 22 to receive and recover a large quantity of requests by using a single connection, so as to avoid repeatedly showing the data requests inputted by the clients 20 or affecting the system operation performance. It is noteworthy that the assigner 211 is used as an intermediate device between the transfer server 21 and the data host 22 for translating the programming language for the data processing, so as to improve the query capability of the big data database system 2 significantly, and the quantity of connections between the clients 20 and the transfer servers 21 is obviously not equal to the quantity of connections between the transfer servers 21 and the data host 22, so as to reduce the network load of the data host 22 significantly.

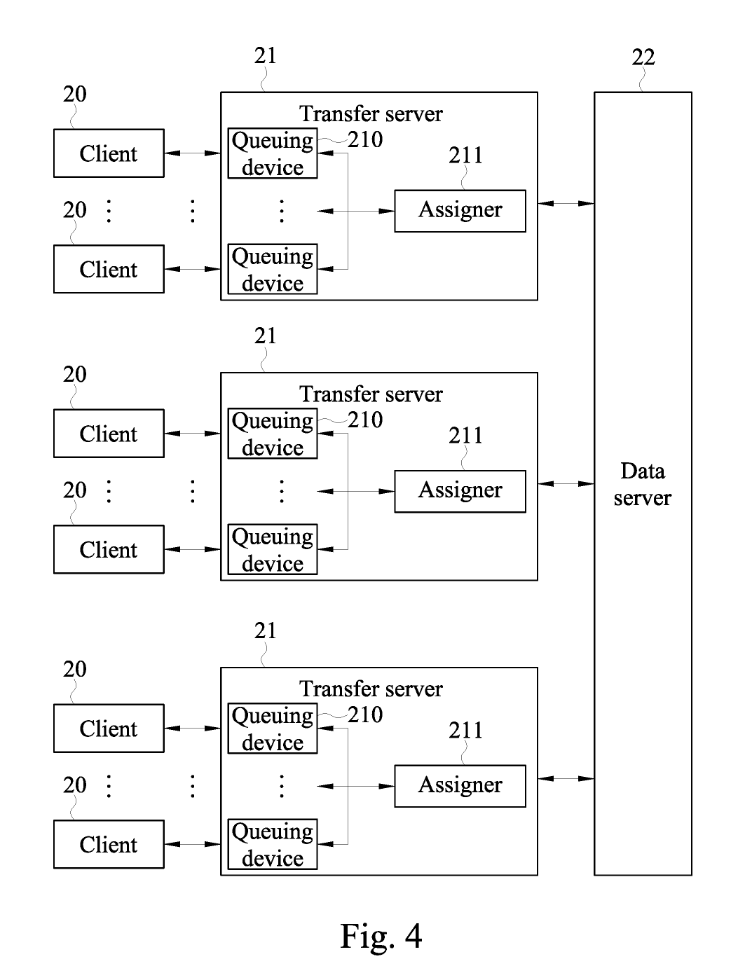

In addition, when the quantity of clients 20 has reached a predetermined number such that the transfer server 21 has reach an upper limit of network connections, another transfer server 21 may be added to the big data database system 2 for automatically receiving the overflow data requests of the clients 20, and a single connection between such transfer server 21 and the data host 22 is also used to sequentially send the data requests to the data host 22. In FIG. 4, if each assigner 210 is just responsible for 4,000 connections, or the quantity of connections is equal to 4K. When there are three transfer servers 21, so that there are a total of 100 assigners 210. Even if there are only 3 connections of the network connection between the data host 22 and the transfer servers 21, the big data database system 2 still can process to 400K connections without errors and achieve the scale much greater than that of the conventional NoSQL database (capable of processing 10K connections only). Undoubtedly, the present invention can overcome the issue of having a large quantity of instructions and data. In other words, if the quantity of transfer servers 21 is equal to a, the quantity of network connections between the data host 22 and the transfer servers 21 will also be equal to a, so as to form a system structure with an asynchronous and asymmetric connection. Since the present invention adopts a distributed computation method, and each transfer server 21 just needs to process the sequence and translation of the data requests, therefore the hardware requirement of each transfer server 21 is not too high and can be increased or decreased flexibly according to the quantity of the clients 20 without affecting the data operation and storage at the rear-end data host 22. In addition, the data host 22 primarily serves as storage for the compressed data table, and each transfer server 21 has the read/write functions and is definitely not just a conventional server-client system structure.

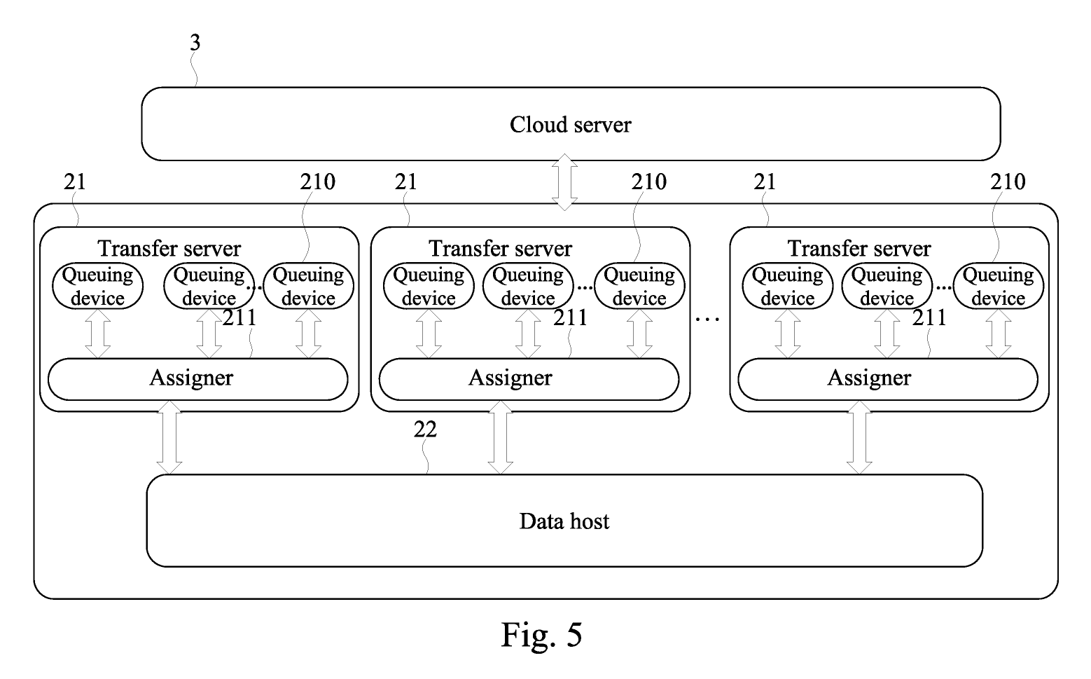

In FIG. 5, the big data database system 2 is applied to a cloud database, and the transfer servers 21 are installed to a cloud server 3, so as to provide services including industrial applications, data analytics applications, functional applications, content analytics, business intelligence reporting (BI/Reporting), etc. The clients 20 may enter into the data host 22 through the cloud networking method in order to inquire, read, or write data. In addition, the data host 22 has a plurality of data sinks (not shown in the figure) corresponding to the transfer servers 21 respectively, and the data sinks may be updated synchronously with one another, so that each assigner 211 can inquire data from the respective data sink to improve the system operation performance.

What is claimed is:

1. A big data database system, created in a language structure of a SQL database and a language structure of a NoSQL database, and provided for accessing data after a plurality of clients have requested for a network connection, characterized in that the big data database system comprises at least one transfer server and a data host, and the transfer server includes a plurality of queuing devices and an assigner, and the queuing devices are respectively and telecommunicatively coupled to the clients, and the assigner is telecommunicatively coupled to the queuing devices and the data host, so that when one of the clients sends out a data request, the respective queuing device receives and queues the data request, and the assigner sends the data request to the data host through a single connection between the transfer server and the data host.

2. The big data database system of claim 1, wherein the assigner sends the data requests to the data host sequentially according to a first-in-first-out message mechanism after reading the data requests from the queuing devices.

3. The big data database system of claim 2, wherein the queuing devices are installed to be corresponsive to the clients respectively, so that each client is connected to the respective queuing device.

4. The big data database system of claim 3, wherein when the transfer server come with a plural quantity, and if the quantity of transfer servers is equal to a, then the quantity of network connections between the data host and the transfer servers will also be equal to a.

5. The big data database system of claim 4, wherein the transfer server and the clients adopt a language technology of a relational database structure.

6. The big data database system of claim 5, wherein the transfer server and the data host adopts a language technology of a non-relational database structure.
